(19) United States
(12) Patent Application Publication
(10) Pub. No.: US 2026/0118615 A1
(43) Pub. Date: Apr. 30, 2026

(54) GANGABLE FIBER OPTIC DISTRIBUTION BOX AND SCALABLE BOX SYSTEM

(71) Applicant: DMSI International, Venice, FL (US)

(72) Inventors: Robert Brewster, Ellijay, GA (US); Brandon Woodward, Venice, FL (US); Philip D. Hall, Venice, FL (US)

(21) Appl. No.: 18/926,032

(22) Filed: Oct. 24, 2024

(51) Int. Cl. G02B 6/44

(52) U.S. Cl. CPC G02B 6/4446

(57) ABSTRACT

A gangable fiber optic distribution box, box assembly, and scalable box system. In embodiments, each gangable fiber optic distribution box includes a housing defining an interior space, a lid removably attached to the top of the housing, at least one lateral projection positioned on a first side and at least one lateral opening positioned on a second side for side-by-side box mounting, and at least one slide lock opening positioned in the lid and at least one slide lock projection positioned on the bottom for top-to-bottom box mounting. In embodiments, each box includes adapters mounted in the front and back and a cable assembly disposed in the interior space and connected to the adapters.

### TECHNICAL FIELD AND BACKGROUND

The present disclosure relates generally to fiber optic equipment, and more particularly, to a gangable fiber optic distribution box, box assembly, and scalable box system.

Fiber topic distribution boxes are used in data centers, office buildings, and other environments to make fiber optic connections. Typically, a supply fiber optic cable is received at the back of the box, splits inside the box, and connects to a plurality of separate fiber optic cables received at the front of the box. The separate fiber optic cables are then routed to other equipment in the installation environment. Traditional fiber optic distribution boxes are dimensioned approximately the same size as a standard building tile to facilitate installation in a floor or ceiling. These traditional boxes are therefore oversized for some applications and undersized for other applications. In addition to sizing issues, traditional fiber optic distribution boxes are not configured to attach to other fiber optic distribution boxes and therefore do not provide a scalable fiber optic distribution solution.

Therefore, what is needed in a fiber optic distribution box that is compact and includes provisions for attaching to other fiber optic distribution boxes to provide a scalable fiber optic distribution solution.

### BRIEF SUMMARY

According to one aspect, the inventive concepts according to the present disclosure are directed to a gangable fiber optic distribution box including a housing having a front, a back, a top, a bottom, a first side, and a second side collectively defining an interior space, a lid removably attached to the top of the housing, at least one lateral projection positioned on the first side of the housing and configured to be received in at least one lateral opening of another gangable fiber optic distribution box, and at least one lateral opening positioned on the second side of the housing and configured to receive at least one lateral projection of another gangable fiber optic distribution box.

In some embodiments, the gangable fiber optic distribution box includes at least one slide lock opening positioned in the lid and configured to receive at least one slide lock projection of another gangable fiber optic distribution box, and at least one slide lock projection positioned on the bottom of the housing and configured to engage in at least one opening positioned in a lid of another gangable fiber optic distribution box.

In some embodiments, the gangable fiber optic distribution box includes at least two lateral projections positioned in spaced apart relation on the first side of the housing, and at least two lateral openings positioned in spaced apart relation on the second side of the housing.

In some embodiments, each lateral projection includes a post and a head, and each lateral opening is elongated and includes a head receiving portion, a middle portion, and a post receiving portion.

In some embodiments, the back of the housing includes at least one opening configured to mount at least one adapter.

In some embodiments, the front of the housing includes at least one opening configured to mount at least one adapter.

In some embodiments, the gangable fiber optic distribution box includes a faceplate removably mounted to the front of the housing, the faceplate including at least one opening configured to mount at least one adapter.

In some embodiments, the gangable fiber optic distribution box includes at least one clip removably attached to the housing.

In some embodiments, the length of the housing is approximately equal to the width of the housing and approximately four times the height of the housing.

In another aspect, the inventive concepts according to the present disclosure are directed to gangable fiber optic distribution box assembly including a housing having a front, a back, a top, a bottom, a first side, and a second side collectively defining an interior space, a lid removably attached to the top of the housing, at least one lateral projection positioned on the first side of the housing and configured to be received in at least one lateral opening of another gangable fiber optic distribution box, at least one lateral opening positioned on the second side of the housing and configured to receive at least one lateral projection of another gangable fiber optic distribution box, at least one adapter mounted in at least one opening in the back of the housing, at least one adapter mounted in at least one opening in the front of the housing, and at least one connectorized fiber optic cable assembly disposed in the interior space and connected to the at least adapter in the back of the housing and the at least one adapter in the front of the housing.

In a further aspect, the inventive concepts according to the present disclosure are directed to a scalable fiber optic distribution box system including at least two gangable fiber optic distribution boxes. In embodiments, each gangable fiber optic distribution box includes a housing having a front, a back, a top, a bottom, a first side, and a second side collectively defining an interior space, a lid removably attached to the top of the housing, the lid including at least one slide lock opening, at least one slide lock projection positioned on the bottom of the housing, at least one lateral projection positioned on the first side of the housing, and at least one lateral opening positioned on the second side of the housing. In use, the at least two gangable fiber optic distribution boxes are removably attachable in at least one of a side-by-side configuration by engagement of the at least one lateral projection of one gangable fiber optic distribution box in the at least one lateral opening of another gangable fiber optic distribution box, and a top-to-bottom configuration by engagement of the at least one slide lock projection of one gangable fiber optic distribution box in the at least one slide lock opening of another gangable fiber optic distribution box.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is top, front and left side isometric view of a gangable fiber optic distribution box assembly shown with the lid detached, in accordance with example embodiments of this disclosure;

FIG. 2 is top, front and left side isometric view of a gangable fiber optic distribution box shown with the lid detached, in accordance with example embodiments of this disclosure;

FIG. 3 is top, front and right side isometric view of the gangable fiber optic distribution box shown with the lid attached, in accordance with example embodiments of this disclosure;

FIG. 4 is bottom, back and left side isometric view of the gangable fiber optic distribution box shown, in accordance with example embodiments of this disclosure;

FIG. 5 is a bottom, back and right side isometric view of the gangable fiber optic distribution box shown, in accordance with example embodiments of this disclosure;

FIG. 6 is an isometric view showing gangable fiber optic distribution boxes attached side-by-side, in accordance with example embodiments of this disclosure;

FIG. 7 is an isometric view showing gangable fiber optic distribution boxes attached side-by-side and top-to-bottom, in accordance with example embodiments of this disclosure; and

FIG. 8 is an isometric view of the gangable fiber optic distribution box showing a removable/interchangeable faceplate, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, this disclosure describes a gangable fiber optic distribution box, fiber optic distribution box assembly, and scalable fiber optic distribution box system. In embodiments, each individual gangable fiber optic distribution box (or simply “box”) is configured to mounted in an installation environment alone or attached to at least one other like box. As connection density increases and decreases in the installation environment, additional boxes may be added or removed from the system easily and in some cases without the use of tools. Each individual box includes provisions on the top, bottom, and lateral sides for removably attaching at least one other box. Boxes may be attached top-to-bottom, side-by-side, and combinations thereof to accommodate any installation environment, mounting location, and connection density. Each box can be configured to accommodate and number and type of fiber optic adapters.

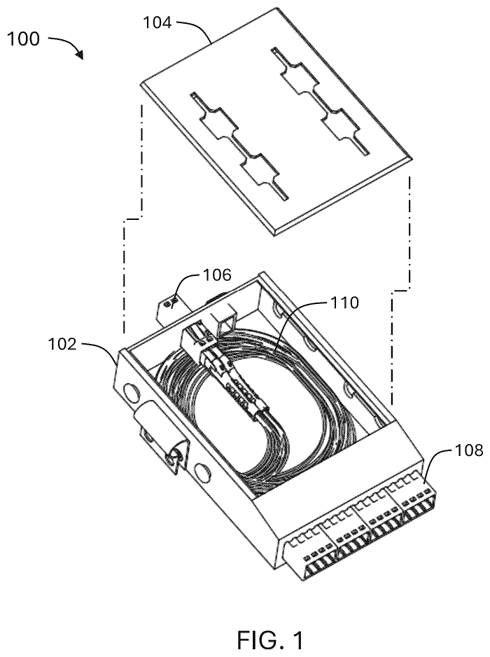

FIG. 1 illustrates a gangable fiber optic distribution box assembly 100 generally including a housing 102, a lid 104 removably attachable to the housing, at least one backside adapter 106, at least one frontside adapter 108, and at least one connectorized cable assembly 110 disposed in the housing and connected to the adapters 106, 108. Each backside adapter 106 may be configured to connect, from outside the housing 102, a multi-fiber connector (e.g., MPO or MMC) of a connectorized input fiber optic cable (not shown). Each frontside adapter 108 may be configured to connect, from outside the housing 102, a multi-fiber connector (e.g., duplex-LC or MDC) of a connectorized output fiber optic cable (not shown). The connectorized cable assembly 110 disposed in the housing 102 connects (optically) to the input and output fiber optic cables to form the ‘splitting’ interconnection. In use, the lid 104 may be removed to access the connectorized cable assembly 110.

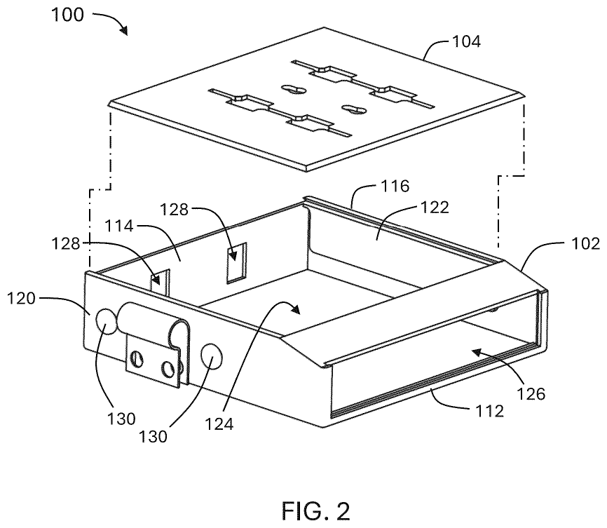

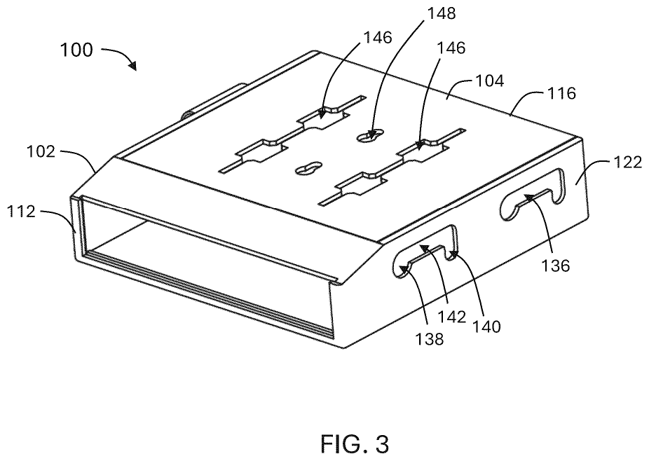

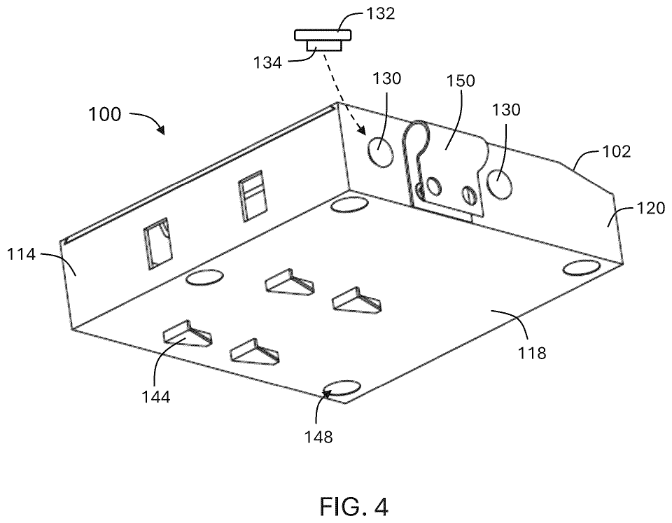

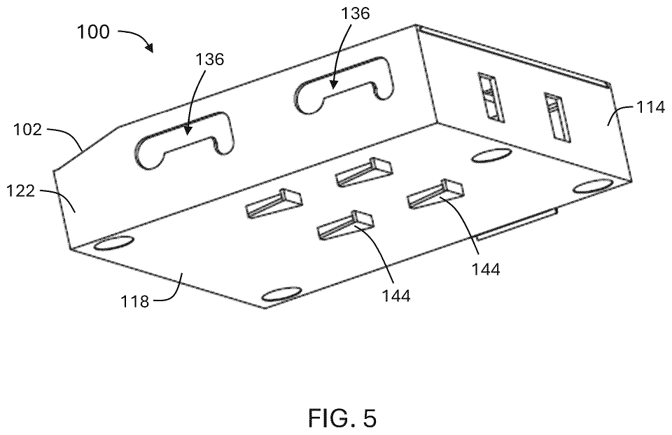

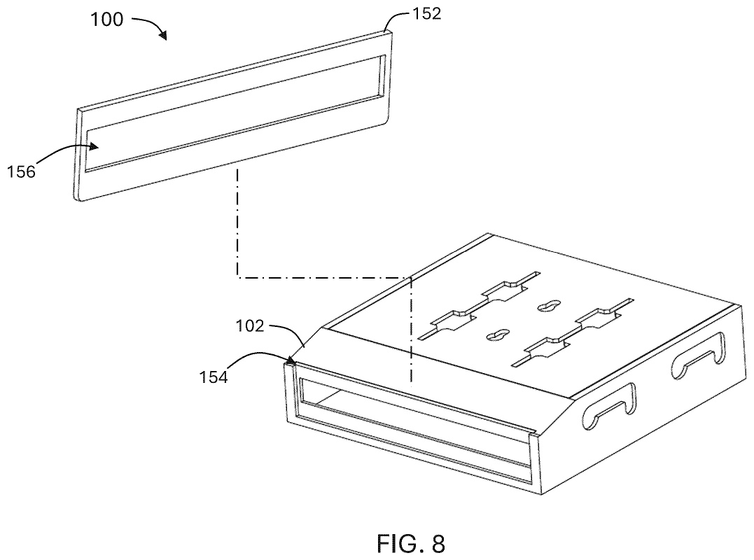

FIGS. 2-5 illustrates various isometric views and assembled states of the gangable fiber optic distribution box 100 shown without the adapters and internal connectorized cable assembly for clarity. The housing 102 has a front 112, a back 114, a top 116, a bottom 118, a first side 120, and a second side 122 collectively defining an interior space 124. In embodiments, the top 116 may be open and closed by the lid 104 to access the interior space 124, while the bottom 118 may be closed. The front 112 may include at least one opening 126 for mounting at least one adapter or may be configured to removably attach a faceplate discussed below with reference to FIG. 8. The back 114 may be substantially closed except for at least one opening 128 for mounting the at least one adapter.

The housing 102 includes at least one lateral projection 130 positioned on the first side 120. In embodiments, the at least one lateral projection 130 may be integrally formed with the housing 102. As shown, the housing 102 includes two spaced apart lateral projections 130 each including a head 132 positioned at one end of a post 134 to distance the head 132 from the lateral side of the housing 102. The housing 102 further includes at least one lateral opening 136 positioned on the second side 122. As shown, the housing 10 includes two spaced apart lateral openings 136 formed through the second lateral side 122. The lateral projections 130 and lateral openings 136 are positioned on opposite sides (does not matter which side) such that the lateral posts 130 of one box are received in the lateral openings 136 of another box to removably attached the two boxes side-by-side.

Each lateral opening 136 may include a head receiving portion 138, a post seating portion 140, and a middle connecting portion 142. In use, to attach or connect two housing or boxes, the heads 132 of the two lateral projections 130 are aligned with and advanced through their respective head receiving portions 138, the posts 134 are then slid along the middle connecting portion 142 until seated in their respective post receiving portions 140. The enlarged heads 132 prevent the attached housings 102 from being pulled apart in the lateral direction, and the depth of the post seatings portions 140 prevents the attached housings 102 from being pulled apart in the longitudinal direction. When attached side-by-side, the housings 102 may be aligned such that their fronts 112 are coplanar, backs 114 are coplanar, tops 116 are coplanar, and bottoms 118 are coplanar.

In embodiments, the number and position of the lateral projections 130 on the first side 120 corresponds to the number and position of the lateral openings 136 on the second side 122 such that each housing 102 can removably attach to two other housings 102 in a side-by-side configuration through engagement of the lateral projections 130 in the corresponding lateral openings 136.

The housing 102 further includes at least one slide lock projection 144 positioned on the bottom 118 of the housing 102, and at least one slide lock opening 146 positioned in the lid 104. In embodiments, the number and position of the slide lock projections 144 on the bottom 118 corresponds to the number and position of the slide lock openings 146 in the lid 104 such that each box can removably attach to two other boxes in a top-to-bottom configuration through engagement of the slide lock projections 144 in the corresponding slide lock openings 146. In embodiments, at least one of the lid 104 and the housing 102 may include openings for wall mounting the housing 102 and lid 104. For example, a lid 104 may be wall mounted to provide slide lock openings 146 for wall mounting a housing 102 slide lock engaged with the wall mounted lid 104. In embodiments, the slide lock openings 146 may be positioned on the bottom 118 of the housing 102 and the slide lock projections 144 may be positioned on the lid 104 to provide the opposite configuration and a flat bottom housing 102.

In embodiments, the lid 104 may have a depth such that the slide lock openings 146 are spaced apart from a bottom of the lid 104 such that the housing 102 is substantially closed, the same is applicable to the lateral openings 136 positioned on the second side 122 (see side panel in FIG. 2 covering openings). In embodiments, the front/top portion of the housing 102 may be ramped or tapered. In embodiments, the gangable fiber optic distribution box 100 may further include at least one clip 150 removably attached to the housing 102.

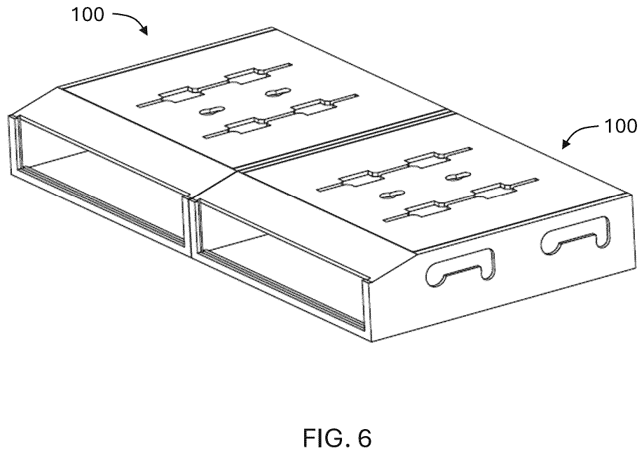

FIG. 6 illustrates two gangable fiber optic distribution boxes 100 removably attached side-by-side to show their relative alignment and close spacing. In embodiments, the distance between the lateral side of the housing and the head may correspond to the thickness of the lateral wall of the box such that the two boxes attach in tight-fitting engagement.

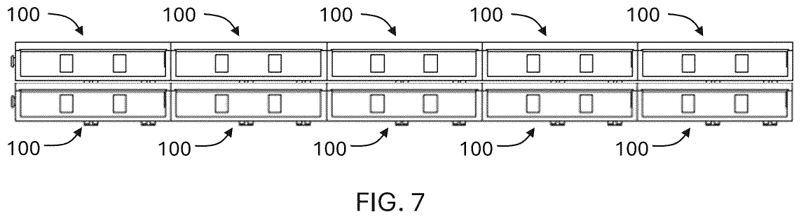

FIG. 7 illustrates a plurality of gangable fiber optic distribution boxes 100 removably attached side-by-side and also top-to-bottom to show the ability to scale the system to increase capacity.

FIG. 8 illustrates a housing configuration including a faceplate 152 removably attachable to the housing 102. In embodiments, the faceplate 152 may install from above by sliding into a groove 154 formed in the front face of the housing 102. The faceplate includes at least one opening 156 for mounting at least one adapter. Different interchangeable faceplates with different opening configurations may be used to provide a universal housing solution for accommodating different adapters and adapter configurations. Although not limited to any particular dimensions, in one embodiment the length and width of the housing may be substantially and approximately four times the height of the housing.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A gangable fiber optic distribution box, comprising:
a housing having a front, a back, a top, a bottom, a first side, and a second side collectively defining an interior space;
a lid removably attached to the top of the housing;
at least one lateral projection positioned on the first side of the housing and configured to be received in at least one lateral opening of another gangable fiber optic distribution box; and
at least one lateral opening positioned on the second side of the housing and configured to receive at least one lateral projection of another gangable fiber optic distribution box.

2. The gangable fiber optic distribution box according to claim 1, further comprising:
at least one slide lock opening positioned in the lid and configured to receive at least one slide lock projection of another gangable fiber optic distribution box; and
at least one slide lock projection positioned on the bottom of the housing and configured to engage in at least one opening positioned in a lid of another gangable fiber optic distribution box.

3. The gangable fiber optic distribution box according to claim 1, comprising:
at least two lateral projections positioned in spaced apart relation on the first side of the housing; and
at least two lateral openings positioned in spaced apart relation on the second side of the housing.

4. The gangable fiber optic distribution box according to claim 1, wherein:
each lateral projection includes a post and a head; and
each lateral opening is elongated and includes a head receiving portion, a middle portion, and a post receiving portion.

5. The gangable fiber optic distribution box according to claim 1, wherein the back of the housing includes at least one opening configured to mount at least one adapter.

6. The gangable fiber optic distribution box according to claim 1, wherein the front of the housing includes at least one opening configured to mount at least one adapter.

7. The gangable fiber optic distribution box according to claim 1, further comprising a faceplate removably mounted to the front of the housing, the faceplate including at least one opening configured to mount at least one adapter.

8. The gangable fiber optic distribution box according to claim 1, further comprising at least one clip removably attached to the housing.

9. The gangable fiber optic distribution box according to claim 1, wherein the length of the housing is approximately equal to the width of the housing and approximately four times the height of the housing.

10. A gangable fiber optic distribution box assembly, comprising:
a housing having a front, a back, a top, a bottom, a first side, and a second side collectively defining an interior space;
a lid removably attached to the top of the housing;
at least one lateral projection positioned on the first side of the housing and configured to be received in at least one lateral opening of another gangable fiber optic distribution box;
at least one lateral opening positioned on the second side of the housing and configured to receive at least one lateral projection of another gangable fiber optic distribution box;
at least one adapter mounted in at least one opening in the back of the housing;
at least one adapter mounted in at least one opening in the front of the housing; and
at least one connectorized fiber optic cable assembly disposed in the interior space and connected to the at least adapter in the back of the housing and the at least one adapter in the front of the housing.

11. The gangable fiber optic distribution box assembly according to claim 10, further comprising:
at least one slide lock opening positioned in the lid and configured to receive at least one slide lock projection of another gangable fiber optic distribution box; and
at least one slide lock projection positioned on the bottom of the housing and configured to engage in at least one opening positioned in a lid of another gangable fiber optic distribution box.

12. The gangable fiber optic distribution box assembly according to claim 10, comprising:
at least two lateral projections positioned in spaced apart relation on the first side of the housing; and
at least two lateral openings positioned in spaced apart relation on the second side of the housing.

13. The gangable fiber optic distribution box assembly according to claim 10, wherein:
each lateral projection includes a post and a head; and
each lateral opening is elongated and includes a head receiving portion, a middle portion, and a post receiving portion.

14. The gangable fiber optic distribution box assembly according to claim 10, further comprising a faceplate removably mounted to the front of the housing, wherein the at least one adapter is mounted in at least one opening in the faceplate.

15. The gangable fiber optic distribution box assembly according to claim 10, further comprising at least one clip removably attached to the housing.

16. A scalable fiber optic distribution box system, comprising:
at least two gangable fiber optic distribution boxes, each gangable fiber optic distribution box comprising:
a housing having a front, a back, a top, a bottom, a first side, and a second side collectively defining an interior space;
a lid removably attached to the top of the housing, the lid including at least one slide lock opening;
at least one slide lock projection positioned on the bottom of the housing;
at least one lateral projection positioned on the first side of the housing; and
at least one lateral opening positioned on the second side of the housing;
wherein the at least two gangable fiber optic distribution boxes are removably attachable in at least one of a side-by-side configuration by engagement of the at least one lateral projection of one gangable fiber optic distribution box in the at least one lateral opening of another gangable fiber optic distribution box, and a top-to-bottom configuration by engagement of the at least one slide lock projection of one gangable fiber optic distribution box in the at least one slide lock opening of another gangable fiber optic distribution box.

17. The scalable fiber optic distribution box system according to claim 16, wherein each gangable fiber optic distribution box includes at least one opening in the back of the housing configured to mount at least one adapter, and at least one opening in the front of the housing configured to mount at least one adapter.

18. The scalable fiber optic distribution box system according to claim 16, wherein each gangable fiber optic distribution box includes a faceplate removably attached to the front of the housing, the faceplate including at least one opening configured to mount at least one adapter.

19. The scalable fiber optic distribution box system according to claim 16, wherein:
each gangable fiber optic distribution box comprises at least two lateral projections positioned in spaced apart relation on the first side of the housing; and
at least two lateral openings positioned in spaced apart relation on the second side of the housing.

20. The scalable fiber optic distribution box system according to claim 16, wherein:
each lateral projection includes a post and a head; and
each lateral opening is elongated and includes a head receiving portion, a middle portion, and a post receiving portion.
